(19) United States
(12) Patent Application Publication
(10) Pub. No.: US 2008/0310886 A1
(43) Pub. Date: Dec. 18, 2008

(54) DEVELOPER REGULATING APPARATUS AND DEVELOPING APPARATUS

(75) Inventors: Yasushi Shimizu, Suntou-gun (JP); Kazunari Hagiwara, Numazu-shi (JP); Shinichi Nishida, Mishima-shi (JP); Hirokazu Usami, Suntou-gun (JP); Hiraku Sasaki, Susono-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/132,935

(22) Filed: Jun. 4, 2008

(30) Foreign Application Priority Data
Jun. 14, 2007 (JP) 2007-157559

(51) Int. Cl. G03G 15/09; G03G 15/08

(52) U.S. Cl. 399/274; 399/284

(57) ABSTRACT

A developer regulating apparatus including: a flexible sheet member, which regulates a thickness of a developer layer on a developing roller; and a holding member having wall surfaces for holding the sheet member in a curved state, wherein when the sheet member is not pressed by the developing roller, an angle of circumference of an arc of the sheet member is not larger than 180 degrees, a perpendicular bisector of a chord corresponding to the arc when the sheet member is pressed by the developing roller is provided downstream in a rotation direction of the developing roller with respect to a normal line of a surface of the developing roller which is parallel to the perpendicular bisector, and a sheet member holding line of the wall surface of the holding member upstream in the rotation direction is provided coplanar with the normal line or upstream of the normal line.

### BACKGROUND OF THE INVENTION

1. Field of the Invention

The present invention relates to a developer regulating apparatus for regulating a thickness of a layer of a developer carried by a developer carrying member and to a developing apparatus including the developer regulating apparatus.

2. Description of the Related Art

Conventionally, for an image forming apparatus for forming an image on a sheet material, as a developing system used for developing an electrostatic latent image formed on a photosensitive drum serving as an image bearing member, there are widely used a contact developing system and a non-contact developing system.

The contact developing system is a development system in which, in a state where a developer carrying member and a photosensitive drum are brought into contact with each other, a developer is supplied from the developer carrying member to the photosensitive drum. On the other hand, the non-contact developing system is a development system in which, in a state where a predetermined gap is formed between the developer carrying member and the photosensitive drum, the developer is flied to be supplied from the developer carrying member onto the photosensitive drum.

Further, as the developer carrying member, an elastic roller is generally used for the contact developing system, and an elastic roller or a metal sleeve is generally used for the non-contact developing system.

In a developing apparatus of each of the development systems, in order to prevent image failures such as blur, coat regulation for making a layer thickness of a coat layer (developer layer) constant, which is formed on a surface of the developer carrying member. As a measure therefor, there is provided a developer regulating apparatus for performing the coat regulation by abutting on the surface of the developer carrying member. Note that, the developer regulating apparatus performs the coat regulation and generates a friction with respect to a developer thereby charging the developer.

The developer regulating apparatus includes a developer regulating member abutting on the surface of the developer carrying member with a predetermined abutment pressure to perform the coat regulation, and a holding member for holding the developer regulating member. Further, as the developer regulating member, there is known a developer regulating member of a cantilever type having a blade shape.

FIG. 22 is a schematic structure of a developer regulating apparatus according to a conventional example. FIG. 22 illustrates the developer regulating apparatus adopting the contact developing system in which a nonmagnetic mono-component toner is used as the developer.

The developer regulating apparatus illustrated in FIG. 22 has a structure in which a developing roller 3 is used as the developer carrying member, and the developing roller 3 is formed on an elastic roller having a dielectric layer. Further, supply of the developer to the developing roller 3 is performed by a supply roller 5 rotated by being brought into contact with the developing roller 3.

The supply roller 5 conveys the developer from a developing apparatus accommodating the developer to allow the developer to adhere onto the surface of the developing roller 3, and temporarily remove the developer which is not supplied to the photosensitive drum and remains on the surface of the developing roller 3.

The coat layer formed on the surface of the developing roller 3 in this manner is subjected to the coat regulation by a developer regulating member 4-c of a cantilever blade shape and is charged further. Note that, the developer regulating member 4-c includes a metal thin plate or a metal thin plate having a resin layer on a surface thereof, and a support metal plate which supports the metal thin plate or the metal thin plate having the resin layer while being bonded thereto.

On the other hand, FIG. 23 illustrates a developer regulating apparatus according to another conventional example, adopting the non-contact developing system in which a magnetic mono-component toner is adopted as the developer.

Here, as the developer carrying member, there is used a developing sleeve 8 including an aluminum base pipe 7 having a resin layer formed thereon. The developer is supplied from the developing sleeve 8 to the photosensitive drum by using a magnetic field formed by a stationary magnet roller provided in the developing sleeve 8.

Further, for the developer regulating member 4-c, blade-shaped rubber is used, and a support metal plate which supports the blade-shaped rubber while being bonded thereto is provided thereto.

In the contact developing system (FIG. 22) and the non-contact developing system (FIG. 23) described above, a developing bias is applied to the developing roller 3 or the developing sleeve 8 provided as the developer carrying member, the developer is supplied onto the photosensitive drum.

However, in the developer regulating apparatus according to the above-mentioned conventional example, the following problem arises.

In order to allow the developer regulating member of the blade shape to stably abut on the developer carrying member, it is necessary that the developer regulating member be firmly fixed to the holding member holding one end in a longitudinal direction of the developer regulating member. Further, when a dimension in the longitudinal direction of the blade shape becomes larger, an abutment state thereof with respect to the developer carrying member becomes more stable. As a result, however, there arises a problem in that downsizing of the developing apparatus becomes difficult.

In contrast, there is proposed a developer regulating apparatus as illustrated in FIG. 24, employing a flexible sheet member (developer regulating member) curved in a U shape to form an arc (Japanese Patent Application Laid-Open No. H06-250509).

The developer regulating apparatus illustrated in FIG. 24 has a structure in which an outer side of the arc of the flexible sheet member curved in the U shape is allowed to abut on the developer carrying member, thereby performing the coat regulation of the surface of the developer carrying member. Note that, the flexible sheet member curved in the U shape is held with its both ends being interposed between wall surfaces formed by the holding member.

As illustrated in FIG. 24, the flexible sheet member of the U shape is held at the both ends thereof by the wall surfaces of the holding member. Accordingly, even when the developer regulating apparatus is used for a long time, there is a low risk of the flexible sheet member being removed from the holding member.

However, with the developer regulating apparatus including the U-shaped flexible sheet member, there is a problem in that it is difficult to control an abutment pressure with respect to the developer carrying member.

That is, in order to regulate a thickness of the coat layer to a predetermined value, it is necessary to appropriately set an inroad amount “s” of the flexible sheet member with respect to the developer carrying member, and to stabilize the abutment pressure of the flexible sheet member at an appropriate value (FIG. 25B). In this case, when a fluctuation amount of the abutment pressure with respect to a fluctuation amount of the inroad amount “s” of the flexible sheet member becomes smaller, the abutment pressure of the flexible sheet member with respect to the developer carrying member can be more easily set.

For example, a posture of the U-shaped flexible sheet member is deformed at a time of rotation of the developer carrying member due to a frictional force thereof. In this case, on the developer carrying member, a magnitude of the frictional force differs between a portion to which the developer adheres and a portion to which the developer does not adhere. Accordingly, the posture of the flexible sheet member fluctuates greatly, and the inroad amount “s” thereof with respect to the developer carrying member also fluctuates greatly. In this case, when the fluctuation amount of the abutment pressure with respect to the fluctuation amount of the inroad amount “s” is large, the abutment pressure of the flexible sheet member fluctuates greatly. As a result, the stable coat regulation becomes difficult.

Further, it is known that, in the developer regulating apparatus having the U-shaped flexible sheet member, when the flexible sheet member becomes larger, the fluctuation amount of the abutment pressure with respect to the fluctuation amount of the inroad amount “s” of the flexible sheet member becomes smaller, thereby facilitating the control of the abutment pressure.

However, when the flexible sheet member is larger, there arises a problem in that downsizing of an apparatus main body becomes difficult. Further, when the flexible sheet member is larger, the flexible sheet member tends to be removed from the holding member, thereby lowering the abutment stability.

As a result, in order to retain a stable abutment state without increasing the size of the flexible sheet member, high design accuracy of the developer regulating apparatus is required.

That is, the invention of the above-mentioned developer regulating apparatus according to the conventional example does not disclose the structure for performing the coat regulation while stabilizing the abutment state of the flexible sheet member by a simple structure capable of downsizing the apparatus main body, which does not require high design accuracy.

### SUMMARY OF THE INVENTION

It is an object of the present invention to provide a developer regulating apparatus having a simple structure in which downsizing of an apparatus main body is achieved, and a developing apparatus including the developer regulating apparatus.

It is another object of the present invention to provide a developer regulating apparatus having a structure in which a pressing state of a flexible sheet member with respect to a developer carrying member is stabilized, and a developing apparatus including the developer regulating apparatus.

It is still another object of the present invention to provide a developer regulating apparatus capable of stably regulating a thickness of a developer layer carried by a developer carrying member, and a developing apparatus including the developer regulating apparatus.

Further features of the present invention will become apparent from the following description of exemplary embodiments with reference to the attached drawings.

### BRIEF DESCRIPTION OF THE DRAWINGS

FIG. 1 is a schematic structural view of a developer regulating apparatus according to Embodiment 1 of the present invention.

FIG. 2 is a schematic structural view of an image forming apparatus according to Embodiment 1 of the present invention.

FIG. 3 is a schematic structural view of a process cartridge according to Embodiment 1 of the present invention.

FIG. 4 is a schematic structural view of a developing apparatus D according to Embodiment 1 of the present invention.

FIG. 5 is a schematic structural view of an image forming apparatus according to Embodiment 2 of the present invention.

FIG. 6 is a schematic structural view of a developing apparatus D according to Embodiment 2 of the present invention.

FIG. 7 is a schematic structural view of a developer regulating apparatus according to Comparative Example 1-1 of the present invention.

FIG. 8 is a schematic structural view of a developer regulating apparatus according to Comparative Example 1-2 of the present invention.

FIG. 9 is a schematic structural view of the developer regulating apparatus according to Embodiment 1 of the present invention (Installation Example 5).

FIG. 10 is a schematic structural view of a developer regulating apparatus according to Comparative Example 5-1 of the present invention.

FIG. 11 is a schematic structural view of a developer regulating apparatus according to Comparative Example 5-2 of the present invention.

FIG. 12 is a schematic structural view of a developer regulating apparatus according to Comparative Example 5-3 of the present invention.

FIG. 13 is a schematic structural view of the developer regulating apparatus according to Embodiment 2 of the present invention (Installation Example 6).

FIG. 14 is a schematic structural view of a developer regulating apparatus according to Comparative Example 6-1.

FIG. 15 is a schematic structural view of a developer regulating apparatus according to Installation Example 7 of the present invention.

FIG. 16 is a schematic structural view of a developer regulating apparatus according to Embodiment 2 of the present invention (Installation Example 8).

FIG. 17 is a graph showing results of measurement of an abutment pressure value with respect to an inroad amount according to Embodiment 1 of the present invention.

FIG. 18 is a graph showing a maximum increase rate of the abutment pressure according to Embodiment 1 of the present invention.

FIG. 19 is a schematic structural view of a developer regulating apparatus according to Installation Example 3 of the present invention.

FIG. 20 shows results of measurement of an abutment pressure with respect to an inroad amount.

FIG. 21 is a schematic structural view of the developer regulating apparatus according to Embodiment 2 of the present invention.

FIG. 22 is a schematic structural view of a developer regulating apparatus according to a conventional example.

FIG. 23 is a schematic structural view of a developer regulating apparatus according to another conventional example.

FIG. 24 is a schematic structural view of a developer regulating apparatus according to still another conventional example.

FIG. 25A is a schematic view illustrating an inroad amount “s” of a flexible sheet member.

FIG. 25B is a schematic view illustrating an inroad amount “s” of a flexible sheet member.

### DESCRIPTION OF THE EMBODIMENTS

Hereinafter, with reference to the drawings, the present invention is described in detail with examples based on embodiments. Note that, dimensions, materials, shapes, relative arrangements, and the like of components described in the embodiments are not intended to limit the scope of the present invention unless there is a restrictive description.

### Embodiment 1

A description is made of a structure of a developer regulating apparatus according to Embodiment 1 of the present invention.

(Overall Structure of an Image Forming Apparatus)

With reference to FIG. 2, a description is made of an overall structure of an image forming apparatus according to this embodiment. FIG. 2 illustrates an overall structure of the image forming apparatus according to this embodiment. In this case, as the image forming apparatus, there is used a full-color laser printer utilizing an electrophotographic process.

The image forming apparatus according to this embodiment includes an image forming apparatus main body A and process cartridges B detachably mountable to the apparatus main body A. Each of the process cartridges B includes a charging device, a developing apparatus, a cleaning device, a photosensitive drum, and the like which are integrated into one. A structure of the process cartridge B is described later.

There are provided the process cartridges B for respective colors including yellow, magenta, cyan, and black. By primary transferring rollers 22y, 22m, 22c, and 22k provided in opposing positions of photosensitive drums of those colors with an intermediate transferring belt 20 being interposed therebetween, toner images of those colors are transferred onto the intermediate transferring belt 20 in an overlapping manner (primary transfer), thereby forming a full color image.

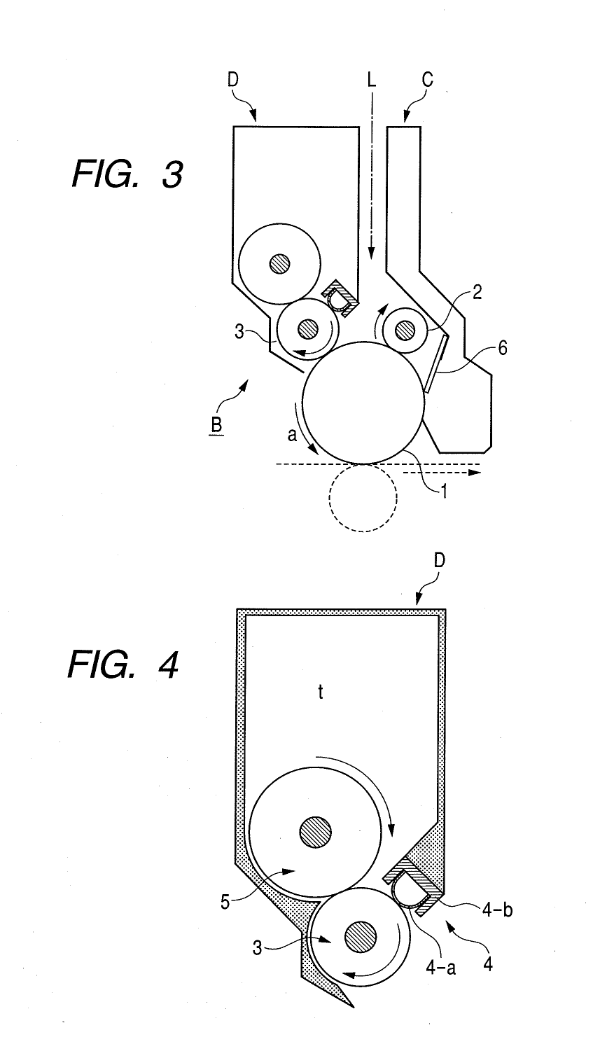

Note that a remaining untransferred toner which is not transferred from the photosensitive drum 1 to the intermediate transferring belt 20 is scraped from a surface of the photosensitive drum 1 by a cleaning blade 6 made of urethane rubber mounted to the cleaning device C and is accommodated in a cleaning container (FIG. 3).

Note that, in this embodiment, as the developer, a nonmagnetic mono-component developer (nonmagnetic toner) having an average particle diameter of 6.0 μm is used.

The full color image primarily transferred onto the intermediate transferring belt 20 is transferred onto a sheet material at once (secondary transfer) by a secondary transferring roller 23 provided downstream in a moving direction of the intermediate transferring belt 20. Note that the untransferred toner on the intermediate transferring belt 20 is recovered by an intermediate transferring belt cleaner 21.

Sheet materials P are stacked in a cassette 24 provided to a lower portion of the image forming apparatus main body A, and each of the sheet materials P is conveyed by a feeding roller 25 in response to request of a printing operation. At a position of the secondary transferring roller 23, the full color image formed on the intermediate transferring belt 20 is transferred onto the sheet material P.

The sheet material on which the full color image is transferred from the photosensitive drum 1 is then heated by a fixing unit 26, thereby fixing the image to the sheet material. The sheet material is then delivered to outside the image forming apparatus through the delivery portion 27.

In this embodiment, an upper unit for accommodating the process cartridges B for four colors or the like, is separable from a lower unit for accommodating a transfer unit and the sheet materials or the like. With this structure, at a time of occurrence of a jam process such as sheet jam or at a time of replacement of the process cartridge B, those processes can be performed by opening the upper unit and the lower unit.

Next, with reference to FIG. 3, a description is made of a structure of the process cartridge B according to this embodiment. FIG. 3 is a schematic structural view of a section of one of the process cartridges B provided for respective colors. Note that structures of the four process cartridges according to this embodiment are essentially the same.

As the photosensitive drum 1 serving as a main component for an image formation process, there is used an organic photoconductive drum including an under coating layer which is a functional film provided on an outer peripheral surface of an aluminum cylinder, a carrier generation layer, and a carrier transport layer in the stated order. In the image formation process, the photosensitive drum 1 is rotated in a direction indicated by the arrow “a” of FIG. 3 at a predetermined speed.

Further, a charging roller 2 provided as an electrostatic charging device is driven to rotate in an arrow direction of FIG. 3 together with the photosensitive drum 1 by allowing a roller portion made of conductive rubber to abut on the surface of the photosensitive drum 1.

In a charging process, a DC voltage of −1100 V applied to a cored bar of the charging roller 2. By an electrical charge induced thereby, a uniform dark part voltage (Vd) of −550 V is formed as a surface voltage of the photosensitive drum 1.

A scanner unit 10 (see FIG. 2) emits a laser light L corresponding to image data to a uniform surface charge distribution surface of the photosensitive drum 1, and the surface of the photosensitive drum 1 is exposed to the light.

In a portion on the surface of the photosensitive drum 1, which is exposed to the light, the electrical charge is eliminated by the carrier from the carrier generation layer, thereby causing reduction in absolute value of the voltage. As a result, there is formed an electrostatic latent image having a bright part voltage V1=−100 V in the exposed portion, and a dark portion voltage Vd=−550 V in the unexposed portion.

To the electrostatic latent image, the developer is supplied from the developing apparatus D, and the electrostatic latent image is developed as a toner image. Specifically, at the time of developing, a DC bias=−350 V is applied to the developing roller 3, thereby the negatively-charged developer on the developing roller 3 is supplied to the electrostatic latent image on the photosensitive drum 1.

(Structure of Developer Regulating Apparatus)

With reference to FIG. 4, a developer regulating apparatus according to this embodiment is described. FIG. 4 illustrates a schematic structure of a developing apparatus D according to this embodiment, including the developer regulating apparatus 4.

The developing apparatus D according to this embodiment includes the developing roller 3 provided as the developer carrying member, the supply roller 5 serving as a developer supply member for supplying the developer to the developing roller 3, and the developer regulating apparatus 4 for regulating a thickness of the layer of the developer carried by the developing roller 3 (for performing a coat regulation). Those members and the developing apparatus D are accommodated in a developing container.

The developer regulating apparatus 4 includes a flexible sheet member 4-a which is pressed onto the surface of the rotating developing roller 3 to regulate the thickness of the developer layer carried by the developing roller 3, and a holding member 4-b for holding the flexible sheet member 4-a. Those structures are described later.

For the developing roller 3, there is used an elastic roller having a diameter of 12 mm including a metal core having an outer diameter of 6 mm and a conductive elastic layer having a thickness of 3 mm formed on the metal core. For the elastic layer, there is used silicone rubber having a volume resistance value of 10⁶ Ωm.

Note that, a surface layer made of a resin having a function of applying an electric charge to the developer may be formed on the surface of the elastic layer. In this embodiment, in order to stably bring the developing roller 3 into elastic contact with the photosensitive drum 1, a hardness of the elastic layer is set to a JIS-A hardness of 45 degrees. Further, in order to obtain a predetermined toner coat amount on the developing roller 3, a surface roughness Rz of the developing roller 3 was set to 6 μm.

As the supply roller 5, there was used an elastic sponge roller having an outer diameter of 16 mm, including a metal core having an outer diameter of 8 mm and an elastic layer having a thickness of 4 mm formed on the metal core. The elastic layer has a volume resistance value of 10¹⁴ Ωcm and is made of insulating urethane sponge rubber.

The developing roller 3 rotates in a forward direction with respect to the rotation direction of the photosensitive drum 1 while abutting on the photosensitive drum 1. The supply roller 5 rotates in the same direction as the rotation direction of the developing roller 3 at a developing position while abutting on the surface of the developing roller 3.

The supply roller 5 is adopted to allow a nonmagnetic mono-component toner agent “t” in the developing container to adhere onto the developing roller 3. Further, the supply roller 5 also has a function of recovering the developer into the developing container by removing the developer which is not used in the development, thereby remaining on the photosensitive drum 1 from the surface of the developing roller 3.

When passing an abutment surface between the developing roller 3 and the U-shaped flexible sheet member 4-a, the nonmagnetic mono-component toner agent supplied from the supply roller 5 onto the developing roller 3 is charged by frictional charging and is subjected to the coat regulation for regulating the layer thickness of the developer layer. As a result, on the surface of the developing roller 3, a toner coat layer having a predetermined charge amount and a coat layer thickness is formed.

(Installation Example of Developer Regulating Apparatus)

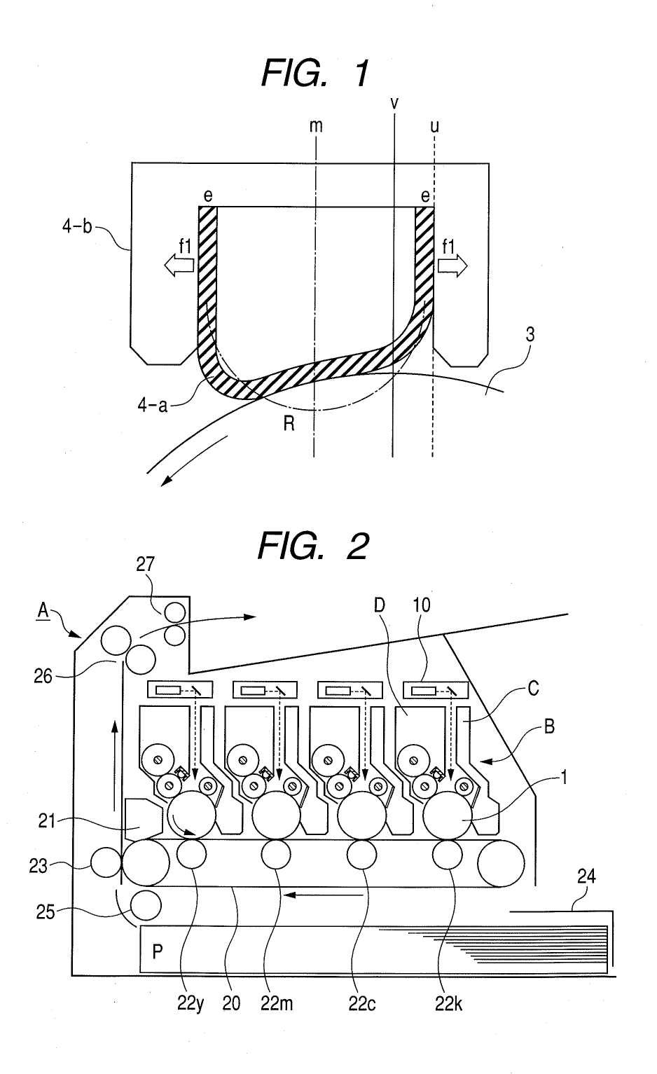

An installation state of the developer regulating apparatus according to this embodiment is described. Note that, in this embodiment, by using the items of the following sections (A) to (C), the installation state of the developer regulating apparatus is defined (see FIG. 1). Further, in this embodiment, downstream in the rotation direction of the developing roller 3 provided as the developer carrying member is defined as downstream, and upstream in the rotation direction of the developing roller 3 is defined as upstream.

(A) Center Line “m” of U-Shaped Flexible Sheet Member 4-a

For illustrating a posture of the U-shaped flexible sheet member 4-a, a line running vertically at a center of the U shape is defined as a center line “m” of the flexible sheet member 4-a. An arc R indicates a position of the flexible sheet member 4-a in a state where the flexible sheet member 4-a is not pressed by the developing roller 3, that is, a state where the developing roller 3 is not provided. The center line “m” is a perpendicular bisector of a chord corresponding to the arc R portion of the U-shaped portion of the curved flexible sheet member 4-a in a state where the flexible sheet member 4-a is not pressed by the developing roller 3 as illustrated in FIG. 1. Note that, the chord is a line segment connecting one end to another end of the circular arc. Accordingly, the chord corresponding to the arc R portion is a line segment connecting upstream points to a downstream point of the flexible sheet member 4-a which is released from holding of the holding member 4-b.

(B) Normal Line “v” of Developer Carrying Member in parallel to Center Line “m” of U-Shaped Flexible Sheet Member 4-a

For illustrating a posture of the U-shaped flexible sheet member 4-a with respect to the developing roller 3, a line which is a straight line parallel to the center line “m” and which serves as a normal line of the developing roller 3 is set to a normal line “v”. That is, at a point where the normal line “v” and the surface of the developing roller 3 cross each other, a tangent drawn on the surface of the developing roller 3 is perpendicular to the normal line “v”.

(C) Supporting Line “u” Coplanar with Upstream Wall Surface of Recess Portion of Holding Member 4-b

A straight line on a surface including an upstream wall surface of opposite wall surfaces which form a recess portion of the holding member 4-b for holding the U-shaped flexible sheet member 4-a is a supporting line (sheet member holding line) “u”.

The developer regulating apparatus 4 according to this embodiment is characterized by an arrangement in that, the center line “m” thereof is positioned downstream of the normal line “v” in the rotation direction of the developing roller 3, and the upstream wall surface of the holding member 4-b is upstream of the normal line “v” in the rotation direction of the developing roller 3. That is, from the downstream to the upstream of the rotating direction of the developing roller 3 (from left to right of FIG. 1), the center line “m”, the normal line “v”, the supporting line “u” are arranged in the stated order.

Further, the holding member 4-b for holding the flexible sheet member 4-a in the curved state holds the opposite ends of the flexible sheet member 4-a such that an angle of circumference of the curved arc R is equal to or smaller than 180 degrees. That is, the holding member 4-b is set so as to hold the flexible sheet member 4-a such that, in the state where the flexible sheet member 4-a is not pressed by the developing roller 3, the angle of circumference of the arc R of the flexible sheet member 4-a is equal to or smaller than 180 degrees.

Hereinafter, arrangement examples of the developer regulating apparatus 4 according to this embodiment are described in (Installation Example 1) to (Installation Example 3), and in comparison with (Comparative Examples) described later, characteristics and effects of this embodiment are described.

### Installation Example 1

In Installation Example 1, as the flexible sheet member 4-a, there was used sheet-shaped urethane rubber having a JIS-A hardness of 65 degrees and a thickness of 0.5 mm. The sheet-shaped urethane rubber was curved in a U shape to form an arc to be fitted into the square U-shaped holding member 4-b having an inner diameter of 6 mm. An outer side of the U-shaped arc was allowed to abut on the surface of the developing roller 3.

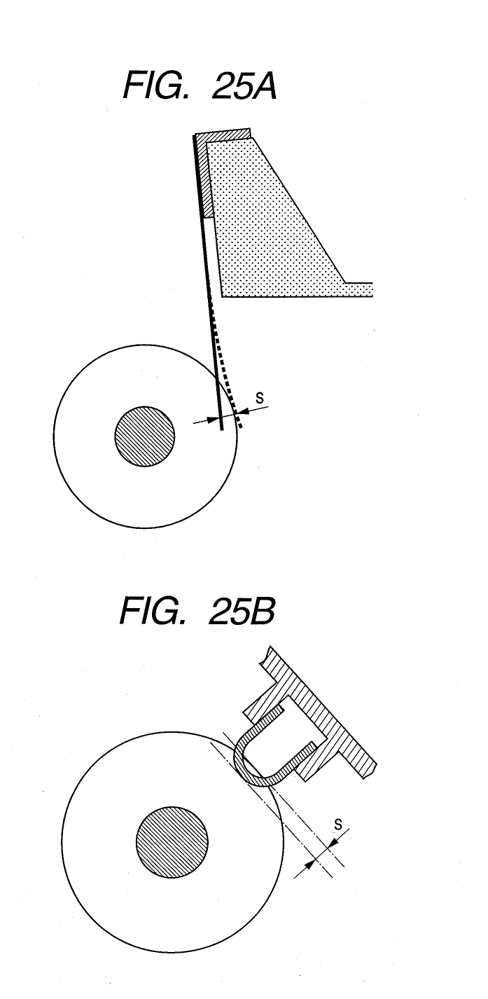

Further, in Installation Example 1, an inroad amount of the flexible sheet member 4-a into the developing roller 3 was set such that an abutment pressure of the flexible sheet member 4-a with respect to developing roller 3 was a line pressure of 0.25 N/cm. The inroad amount is, as illustrated by a distance “s” in FIG. 25B, a distance between a position of the flexible sheet member 4-a which is not pressed by the developing roller 3 and a position of the flexible sheet member 4-a pressed by the developing roller 3 in a normal developing operation.

Note that, in this embodiment, a sheet type pressure sensor system I-SCAN (manufactured by NITTA CORPORATION) was interposed in the abutment portion between the flexible sheet member 4-a and the developing roller 3, thereby measuring the abutment pressure of the flexible sheet member 4-a with respect to the developing roller 3.

Further, in Installation Example 1, the opposite wall surfaces of the recess portion of the holding member 4-b for holding the opposite ends of the flexible sheet member 4-a in the curved state are parallel to each other. As a result, the angle of circumference of the arc of the flexible sheet member 4-a can be made equal to or smaller than 180 degrees.

Further, the flexible sheet member 4-a is not bonded to the opposite wall surfaces of the recess portion of the holding member 4-b. By a repulsive force f1 of the flexible sheet member 4-a itself generated by being bent in the U shape, the flexible sheet member 4-a presses the opposite wall surfaces of the recess portion of the holding member 4-b, thereby holding the posture thereof (see FIG. 1).

Further, flexible sheet member 4-a is allowed to abut on the developing roller 3 with a predetermined abutment pressure, at a bottom surface of the recess portion of the holding member 4-b, edge surfaces “e” of the opposite end portions of the flexible sheet member 4-a is held, thereby stabilizing the posture of the flexible sheet member 4-a. The bottom surface of the recess portion of the holding member 4-b is a surface connecting the edge surfaces “e” of the opposite end portions of FIG. 1 to each other.

Note that, when a frictional force between the edge surfaces “e” of the opposite end portions of the flexible sheet member 4-a and the bottom surface of the recess portion of the holding member 4-b becomes higher, the holding state of the flexible sheet member 4-a becomes more stable. Further, when areas of the edge surfaces “e” are small, the edge surfaces “e” may be directly bonded to the bottom surface of the holding member 4-b.

In Installation Example 1, the developer regulating apparatus 4 was disposed such that the center line “m” was downstream in the rotation direction of the developing roller 3 with respect to the normal line “v” of the developing roller 3, and a distance (m-v) from the center line “m” to the normal line “v” was 2.0 mm. In this case, the supporting line “u” is positioned upstream of the normal line “v” in the rotation direction of the developing roller 3.

### Installation Example 2

In Installation Example 2, a structure of the developer regulating apparatus 4 is not different at all from that of Installation Example 1 described above, so a detailed description thereof is omitted. In Installation Example 2, the developer regulating apparatus 4 was disposed such that the center line “m” is positioned downstream of the normal line “v” of the developing roller 3, and the distance (m-v) from the center line “m” to the normal line “v” is 1.0 mm. In this case, the supporting line “u” is positioned upstream of the normal line “v”.

### Installation Example 3

In Installation Example 3, a structure of the developer regulating apparatus 4 is not different at all from that of Installation Example 1 described above, so a detailed description thereof is omitted. In Installation Example 3, the developer regulating apparatus 4 was disposed such that the center line “m” was downstream of the normal line “v” on the surface of the developing roller 3 in the rotation direction of the developing roller 3, and the distance (m-v) from the center line “m” to the normal line “v” was 2.8 mm. In this case, the supporting line “u” is on substantially the same line as the normal line “v”.

In this case, in order to verify effects of (Installation Example 1) to (Installation Example 3) described above, as comparative examples for (Installation Example 1) to (Installation Example 3), (Comparative Example 1-1) and (Comparative Example 1-2) were provided as follows. Note that, results of the comparison therebetween are described later by using Table 1.

### Comparative Example 1-1

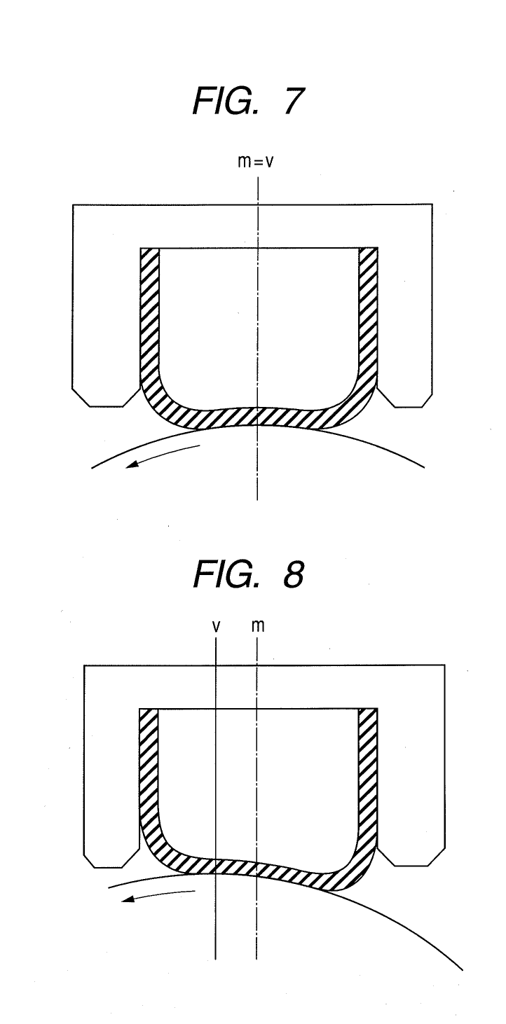

FIG. 7 illustrates a schematic structure of Comparative Example 1-1. Compared to (Installation Example 1) to (Installation Example 3) described above, Comparative Example 1-1 is different therefrom in installation state of the U-shaped flexible sheet member 4-a.

Note that, the abutment pressure of the flexible sheet member 4-a with respect to the developing roller 3 is set to the same value as that of (Installation Example 1) to (Installation Example 3), and physical property or the like of the rubber sheet used is also the same as that of (Installation Example 1) to (Installation Example 3). In Comparative Example 1-1, the setting was performed such that the center line “m” is on the same line as the normal line “v”, that is, a vertex of the curved U-shaped arc abuts on the surface of the developing roller 3.

### Comparative Example 1-2

FIG. 8 illustrates a schematic structure of Comparative Example 1-2. Compared to (Installation Example 1) to (Installation Example 3) described above, Comparative Example 1-2 is different therefrom in installation state of the U-shaped flexible sheet member 4-a.

Note that, the abutment pressure of the flexible sheet member 4-a with respect to the developing roller 3 is set to the same value as that of (Installation Example 1) to (Installation Example 3), and physical property or the like of the rubber sheet used is the same as that of (Installation Example 1) to (Installation Example 3). In Comparative Example 1-2, the setting was performed such that the center line “m” was upstream of the normal line “v” in the rotation direction of the developing roller 3, and the distance from the center line “m” to the normal line “v” was 1.0

### Installation Example 4

Next, a description is made of (Installation Example 4) which is different from (Installation Example 1) to (Installation Example 3) described above, and which illustrates an installation state of the developer regulating apparatus 4 according to this embodiment.

A basic structure of the developer regulating apparatus 4 according to Installation Example 4 is the same as that of (Installation Example 1) to (Installation Example 3), and a structure thereof in which the center line “m” of the U-shaped flexible sheet member 4-a is shifted downstream by 2.8 mm from the normal line “v” in the rotation direction of the developing roller 3 is also the same as that of (Installation Example 3).

However, this installation example is different from (Installation Example 3) in a point that the flexible sheet member 4-a is bonded and fixed to the upstream wall surface of the opposite wall surfaces forming the recess portion of the holding member 4-b.

### Installation Example 5

Next, a description is made of (Installation Example 5) which is different from (Installation Example 1) to (Installation Example 4) described above, and which illustrates an installation state of the developer regulating apparatus 4 according to this embodiment.

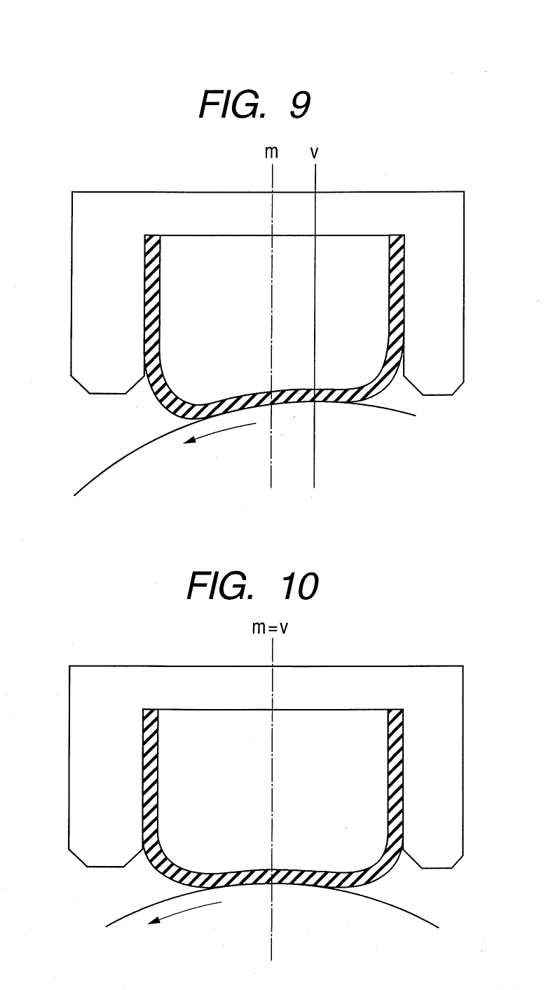

FIG. 9 illustrates a schematic structure of the developer regulating apparatus 4 according to Installation Example 5. In Installation Example 5, sheet-shaped urethane rubber having JIS-A hardness of 75 degrees and a thickness of 0.4 mm was used for the flexible sheet member 4-a. The flexible sheet member 4-a was curved in the U shape and was fitted into the holding member 4-b having a shape of a recess portion of an inner diameter of 7 mm, and a portion of the U-shaped arc was allowed to abut on the surface of the developing roller 3.

Further, the inroad amount was set such that the abutment pressure with respect to the developing roller 3 was a line pressure of 0.25 N/cm. That is, the structure according to Installation Example 5 is different from that of (Installation Example 1) to (Installation Example 4) in shape and performance of the sheet-shaped urethane rubber used for the flexible sheet member 4-a and dimension of the holding member 4-b.

Note that, the opposite wall surfaces of the recess portion of the holding member 4-b are provided so as to be parallel to each other. The flexible sheet member 4-a is held without being bonded to the holding member 4-b. In Installation Example 5, the installation is performed such that the center line “m” is downstream of the normal line “v” in the rotation direction of the developing roller 3, and the distance (m-v) from the center line “m” to the normal line “v” is 1.0 mm.

In this case, in order to verify the effects of (Installation Example 5), as a comparative example for (Installation Example 5), (Comparative Example 5-1) to (Comparative Example 5-3) are provided as described below. Note that, the results of the comparison therebetween are described later.

### Comparative Example 5-1

FIG. 10 illustrates a schematic structure of Comparative Example 5-1. Compared to (Installation Example 5) described above, Comparative Example 5-1 is different therefrom in installation state of the U-shaped flexible sheet member 4-a.

The abutment pressure of the flexible sheet member 4-a with respect to the developing roller 3 is set to the same value as that of (Installation Example 5), and physical property or the like of the rubber sheet used is also the same as that of (Installation Example 5). In Comparative Example 5-1, the setting is performed such that the center line “m” is on the same line as the normal line “v” on the surface of the developing roller 3, and the vertex of the U-shaped arc abuts on the surface of the developing roller 3.

### Comparative Example 5-2

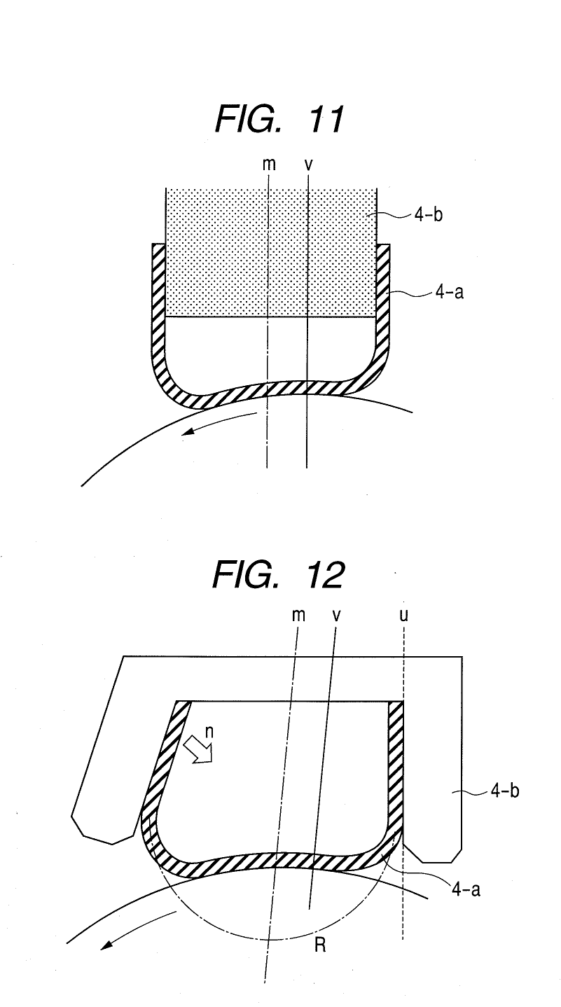

FIG. 11 illustrates a schematic structure of Comparative Example 5-2. Compared to (Installation Example 5) described above, Comparative Example 5-2 is different therefrom in installation state of the U-shaped flexible sheet member 4-a.

The abutment pressure of the flexible sheet member 4-a with respect to the developing roller 3 is set to the same value as that of (Installation Example 5), and physical property or the like of the rubber sheet used is also the same as that of (Installation Example 5).

In Comparative Example 5-2, to the plate-like holding member 4-b having a thickness of 6.2 mm, the inner surface of the curved flexible sheet member 4-a is affixed and is formed into the U shape to be used. Further, like in (Installation Example 5), the arrangement was established such that the center line “m” was downstream of the normal line “v” in the rotation direction of the developing roller 3, and the distance (m-v) from the center line “m” to the normal line “v” was 1.0 mm.

### Comparative Example 5-3

FIG. 12 illustrates a schematic structure of Comparative Example 5-3. Compared to (Installation Example 5) described above, Comparative Example 5-3 is different therefrom in installation state of the U-shaped flexible sheet member 4-a.

Also in Comparative Example 5-3, for the flexible sheet member 4-a, sheet-shaped urethane rubber having a JIS-A hardness of 75 degrees and a thickness of 0.4 mm is used and is bent in the U shape to be fitted into the holding member 4-b. A convex portion of the U shape was allowed to abut on the developing roller 3. Further, the inroad amount was set to a predetermined amount such that the abutment pressure with respect to the developing roller 3 was a line pressure of 0.25 N/cm.

In Comparative Example 5-3, the opposite walls forming the recess portion of the holding member 4-b for holding the flexible sheet member 4-a was provided so as to widen toward the developing roller 3. That is, there was provided a structure in which the angle of circumference of the curved arc of the flexible sheet member 4-a exceeds 180 degrees.

Note that, the structure in which the angle of circumference of the arc of the flexible sheet member 4-a exceeds 180 degrees is provided only in this comparative example.

In Comparative Example 5-3, the wall surfaces forming the recess portion of the holding member 4-b each have an inclination of 16 degrees. In a state prior to abutment of the flexible sheet member 4-a on the developing roller 3, a width between the opposite ends of the chord is set to about 7 mm.

Further, the arrangement was established such that the center line “m” was downstream of the normal line “v”, and the distance (m-v) from the center line “m” to the normal line “v” was 1.0 mm. In this case, the supporting line “u” is positioned upstream of the normal line “v” in the rotation direction of the developing roller 3.

(Consideration Based on Results of Comparison Between Installation Examples and Comparative Examples)

Table 1 shows results of comparison between (Installation Example 1) to (Installation Example 5) of the developer regulating apparatus 4 according to this embodiment described above and the comparative examples. Hereinafter, based on the results of comparison shown in Table 1, characteristics and effects of the developer regulating apparatus 4 according to this embodiment are described.

TABLE 1

| | | Position of | Upstream | | | | | | | | | Stability | |
|---|---|---|---|---|---|---|---|---|---|---|---|---|---|
| | | symmetric | surface | | | | | | | | | of | |
| | Develop- | line with | with | | | | | | | Abut- | | down- | |
| | ment | respect to | respect to | | Sheet | | | | Design | ment | Posture | stream | Total |
| | struc- | normal | normal | Support | bonding | Holding | Thick- | Hard- | toler- | pressure | pressure | surface | eval- |
| | ture | line | line | surface | surface | width | ness | ness | ance | increase | change | sheet | uation |
| Installation | Embodi- | Downstream | Upstream | Parallel | none | 6 mm | 0.5 | 65 | ∘ | ∘ | ∘ | ∘ | ∘ |
| Example 1 | ment 1 | 2.0 mm | | | | | | | | | | | |
| Installation | | Downstream | Upstream | Parallel | none | 6 mm | 0.5 | 65 | Δ | ∘ | ∘ | ∘ | Δ |
| Example 2 | | 1.0 mm | | | | | | | | | | | |
| Installation | | Downstream | Same | Parallel | none | 6 mm | 0.5 | 65 | ∘ | ∘ | Δ | Δ | Δ |
| Example 3 | | 2.8 mm | | | | | | | | | | | |
| comparative | | Same | Upstream | Parallel | none | 6 mm | 0.5 | 65 | Δ | x | x | ∘ | x |
| Example 1-1 | | | | | | | | | | | | | |
| comparative | | Upstream | Upstream | Parallel | none | 6 mm | 0.5 | 65 | Δ | x | ∘ | ∘ | x |
| Example 1-2 | | 1.0 mm | | | | | | | | | | | |
| Installation | | Downstream | Same | Parallel | Upstream | 6 mm | 0.5 | 65 | ∘ | ∘ | ∘ | ∘ | ∘ |
| Example 4 | | 2.8 mm | | | | | | | | | | | |
| Installation | | Downstream | Upstream | Parallel | none | 7 mm | 0.4 | 75 | ∘ | ∘ | ∘ | ∘ | ∘ |
| Example 5 | | 1.0 mm | | | | | | | | | | | |
| Comparative | | Same | Upstream | Parallel | none | 7 mm | 0.4 | 75 | ∘ | x | x | ∘ | x |
| Example 5-1 | | | | | | | | | | | | | |
| Comparative | | Downstream | Upstream | Parallel | Inner | 7 mm | 0.4 | 75 | ∘ | ∘ | x | ∘ | x |
| Example 5-2 | | 1.0 mm | | | surface | | | | | | | | |
| Comparative | | Downstream | Upstream | Widened | none | 7 mm | 0.4 | 75 | ∘ | ∘ | ∘ | x | x |
| Example 5-3 | | 1.0 mm | | recess | | | | | | | | | |
| Installation | Embodi- | Downstream | Upstream | Parallel | none | 6 mm | 0.5 | 65 | ∘ | ∘ | ∘ | ∘ | ∘ |
| Examle 6 | ment 2 | 2.0 mm | | | | | | | | | | | |
| Comparative | | Same | Upstream | Parallel | none | 6 mm | 0.5 | 65 | Δ | x | x | ∘ | x |
| Example 6-1 | | | | | | | | | | | | | |
| Installation | | Downstream | Upstream | Parallel | none | 6 mm | 0.5 | 65 | Δ | Δ | Δ | ∘ | Δ |
| Example 7 | | 1.0 mm | | | | | | | | | | | |
| Installation | | Downstream | Upstream | Tapered | none | 6 mm | 0.5 | 65 | Δ | ∘ | ∘ | ∘ | Δ |
| Example 8 | | 1.0 mm | | recess | | | | | | | | | |

Items in Table 1 are described below.

### Setting Conditions of Table 1

Position of symmetric line with respect to normal line: The symmetric line indicates a center line “m” of the flexible sheet member 4-a of a U shape, and is a symmetric line of an arc formed by the flexible sheet member 4-a (perpendicular bisector of chord). This item indicates a positional relationship between the symmetric line and the normal line “v” parallel thereto. For example, a term (downstream 2.8 mm) means that the center line “m” is provided downstream by 2.8 mm in the rotation direction of the developing roller 3 from the normal line “v”.

Upstream surface with respect to normal line: The upstream surface is a wall surface upstream in the rotation direction of the developer carrying member of wall surfaces constituting the recess portion of the holding member 4-b for holding the flexible sheet member 4-a, and the positional relationship between the upstream surface and the normal line “v” is indicated. That is, a term “upstream” means that the supporting line (sheet member holding line) u is upstream of the normal line “v”.

Supporting surface: This represents a relationship between the upstream wall surface and the downstream wall surface of the both wall surfaces forming the recess portion of the holding member 4-b for holding the flexible sheet member 4-a.

Sheet bonding surface: This represents whether or not a flexible sheet member used as the flexible sheet member 4-a is bonded to the holding member 4-b. Note that, light bond is regarded as “none”.

Holding width: This represents a distance between the wall surfaces forming the recess portion of the holding member 4-b for holding the flexible sheet member 4-a.

Thickness: This represents a thickness of the flexible sheet member 4-a. A unit thereof is mm.

Hardness: This represents a hardness of the flexible sheet member 4-a. The measurement is performed for Asker C hardness.

Evaluation Items of Table 1

Design tolerance: This is obtained as a result of checking the change in abutment pressure with respect to the inroad amount. There arises a problem in that the larger the change in abutment pressure with respect to the inroad amount is, the narrower a latitude becomes under the design conditions.

Abutment pressure increase: This is obtained as a result of checking a degree of increase in abutment pressure due to posture deformation or the like of the flexible sheet member 4-a involved in rotation of the developer carrying member. There arises a problem in that in a case where a pressure increase from a basic state is large, a large load is applied to the flexible sheet member 4-a, the developer carrying member, the developer, or the like.

Posture pressure change: This is obtained as a result of checking the change in abutment pressure involved in the posture change. A structure having a large abutment pressure change or easily causing pressure change may involve the problem of the load or a problem in that the design tolerance in the abutment pressure setting becomes smaller.

Stability of downstream surface sheet: This is obtained as a result of checking whether the downstream surface of the flexible sheet member 4-a is pressed to be stably supported by the holding member 4-b. When this point is poor, there arises a problem in that the flexible sheet member 4-a cannot be supported in a favorable manner, and thereby being easily rolled up.

Total evaluation: Evaluation summarized regarding each of the items.

For the above-mentioned four evaluation items, a sign x indicates an unallowable level, a sign Δ indicates an allowable level, and a sign ∘ indicates a favorable level. A difference between the allowable level and the favorable level is as follows. For example, when assembly can be achieved, for the design tolerance, the level is indicated by the sign Δ, while when the design tolerance is so wide that no testing is necessary, the level is ∘, etc. That is, a case involving a point markedly superior to a case at the allowable level is set to the favorable level.

As shown in Table 1, it is understood that structures of the comparative examples include items of an unallowable level, but structures of (Installation Example 1) to (Installation Example 5) are at least an allowable level or higher for the all items. Note that, the installation example including many items of the level Δ is said to be within a borderline region of structural conditions of the present invention.

(Consideration regarding Installation Examples 1, 2, and 3 and Comparative Examples 1-1, and 1-2)

Hereinafter, there are provided considerations based on comparison results between the above-mentioned (Installation Example 1) to (Installation Example 3) of the developer regulating apparatus 4 and (Comparative Example 1-1) and (Comparative Example 1-2) corresponding thereto.

(Design Tolerance)

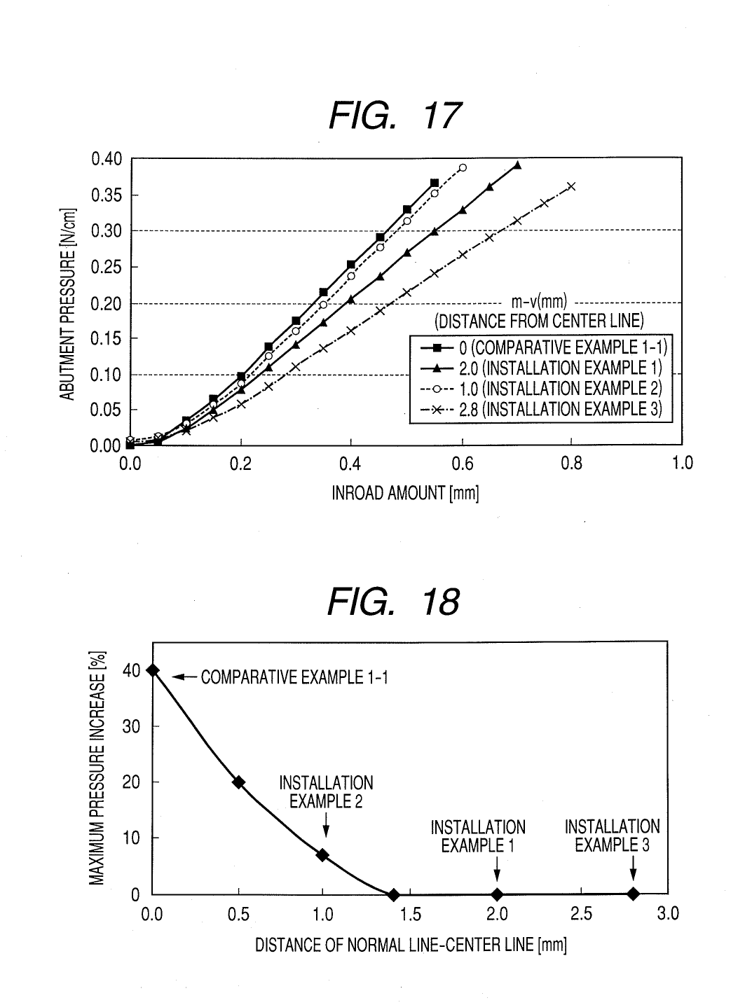

FIG. 17 illustrates measurement results for abutment pressure values with respect to the inroad amount in (Installation Example 1) to (Installation Example 3) and (Comparative Example 1-1).

As illustrated in FIG. 17, compared to a graph of Comparative Example 1-1, graphs of (Installation Example 1) and (Installation Example 3) have moderate inclination. Accordingly, it is understood that in (Installation Example 1) and (Installation Example 3), an abutment pressure change with respect to the inroad amount change is smaller. This means that the set latitude is wide. Further, also in (Installation Example 2), although a difference as large as the differences in (Installation Example 1) and (Installation Example 3) is not seen, inclination thereof is moderate compared to that of (Comparative Example 1-1), and constant effects could be obtained.

(Abutment Pressure Increase)

A maximum increase rate of the abutment pressure in (Installation Example 1) to (Installation Example 3) and Comparative Example 1-1 in a case where the U-shaped flexible sheet member 4-a is deformed is illustrated in FIG. 18.

In this embodiment, increase of the abutment pressure, at a time when the flexible sheet member 4-a is dragged in a normal use state by a frictional force due to rotation of the developing roller 3 to be changed in its posture, from the abutment pressure in the initial state, that is, the abutting state, is measured.

Note that, in an experiment, a lubricant substance such as the developer was not interposed between the developing roller 3 and the flexible sheet member 4-a, and the measurement was performed in a state with an extremely high frictional coefficient to cause extreme deformation of the flexible sheet member 4-a, which is hardly caused in the normal use state of the image forming apparatus.

In this embodiment, a pressure sensor was provided to a bearing portion of the developing roller 3. The developing roller 3 was rotated little by little to deform the flexible sheet member 4-a, and a value at a time when the pressure was maximum at the bearing portion of the developing roller 3 was measured. The term “maximum pressure increase (%)” for a vertical axis of the graph of FIG. 18 indicated a rate of increase from the initial abutment pressure to the maximum abutment pressure with respect to the initial abutment pressure.

Note that, in a process of performing rotation of the developing roller 3 within a torque range of a general motor, there was not caused a phenomenon in which the deformation of the flexible sheet member 4-a becomes larger, thereby causing the flexible sheet member 4-a to be detached from the holding member 4-b.

Under conditions of Comparative Example 1-1, along with the rotation of the developer carrying member, the posture of the flexible sheet member 4-a was changed to increase the abutment pressure. The abutment pressure at the time when the deformation is maximum was 140% of the initial abutment pressure. That is, the vertical axis of the graph of FIG. 18 indicates the rate of increase of the abutment pressure with respect to the initial abutment pressure, so the graph reads 40%.

On the other hand, in Installation Examples 1 and 3, the abutment pressure did not increase but rather decreased. That is, in the graph of FIG. 18, the rate of increase was indicated as 0%. Further, in Installation Example 2, by the rotation of the developer carrying member, the abutment pressure increased to 107% at maximum, but decreased by further rotation. Accordingly, in the graph of FIG. 18, the ratio of increase was indicated as 7%. It is favorable that the maximum increase of the abutment pressure in the apparatus use with respect to the initial abutment pressure be as small as possible.

In order to make a further consideration to those results, a research was made for cases which were not represented in the above-mentioned Installation Examples 1 to 3, where a distance from the center line “m” to the normal line “v” on the surface of the developing roller 3 was 0.5 mm, and where the distance 1.5 mm, the results as illustrated in FIG. 18 were obtained, and there was a correlation with the distance.

This is considered to be the correlation caused because curvature of the developer carrying member changes along with the deformation of the flexible sheet member 4-a. Note that, in the case of Comparative Example 1-2, the maximum abutment pressure was higher than that in Comparative Example 1-1.

(Posture Change of Flexible Sheet Member)

A consideration is made as to a relationship between the deformation of the developer carrying member and the change of the abutment pressure in (Installation Example 1), (Installation Example 2), and Comparative Example 1-1.

In an experiment, the developer carrying member was rotated forward and was rotated slightly backward in consideration to backlash or the like, the deformation of the flexible sheet member 4-a during the rotation was observed, and the change of the abutment pressure at the time of deformation was measured.

In both (Installation Example 1) and (Installation Example 2), the change in posture was small and a pressure decrease in the deformation was also small.

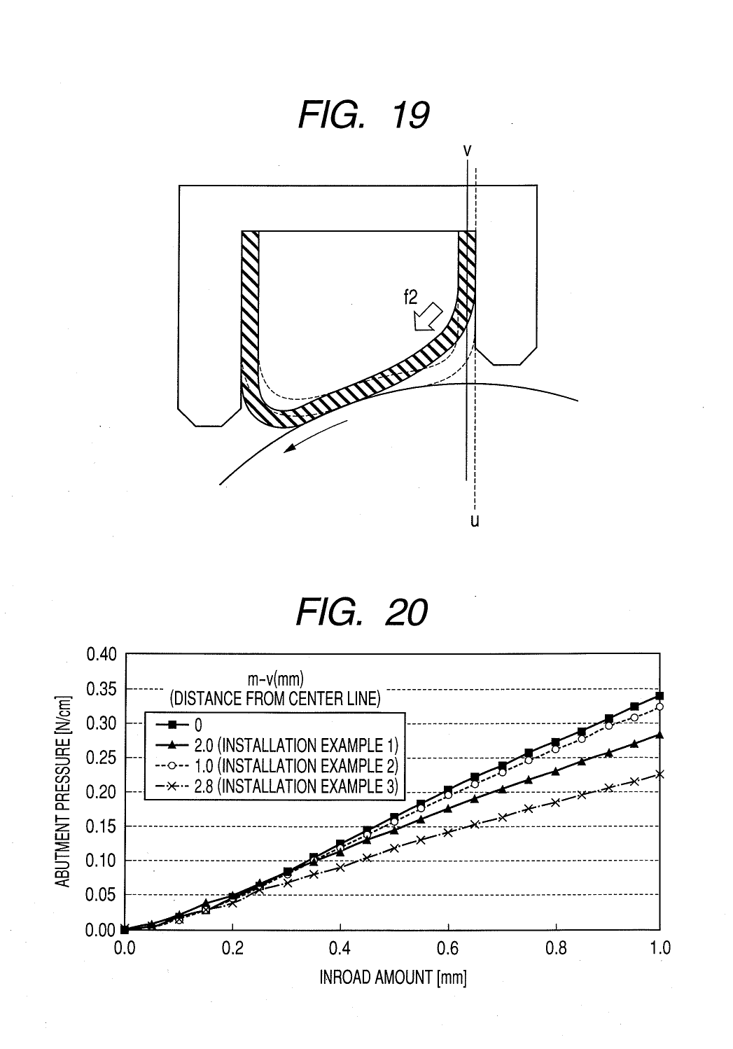

On the other hand, in (Installation Example 3), by the deformation of the flexible sheet member 4-a in the forward rotation direction of the developer carrying member as shown in FIG. 19, the abutment pressure decreased about 30% at maximum.

In order to maintain the abutment pressure constant, with estimation of an actual use state, the inroad amount of the flexible sheet member 4-a is increased, so the solution can be made.

Note that, in a case where the supporting line “u” is downstream of the normal line “v”, even in a case with no rotation of the developer carrying member, only by a pressure of the flexible sheet member 4-a and the developer carrying member, the deformation of the flexible sheet member 4-a becomes larger, thereby causing the posture thereof to be unstable.

In (Installation Example 4), the flexible sheet member 4-a is bonded to the holding member 4-b by the same structure as that in (Installation Example 3). Accordingly, the posture deformation can be suppressed, and the change in abutment pressure involved therein can also be suppressed.

Note that, although not represented as evaluation items in Table 1, of a structure with a bonding surface and a structure without bonding, the structure without bonding is superior in the number of manufacturing processes, demand of adhesion surface accuracy, or the like.

In Comparative Example 1-1, the increase in abutment pressure by the posture deformation is as described above. However, also in the backward rotation of the developer carrying member, the posture is deformed, thereby causing the abutment pressure increase. That is, in Comparative Example 1-1, with respect to the slight rotation of the developer carrying member, the change in abutment pressure is large.

(Consideration Regarding Installation Example 5 and Comparative Examples 5-1, 5-2, and 5-3)

Hereinafter, consideration based on results of the comparison between the above-mentioned (Installation Example 5) of the developer regulating apparatus 4, and (Comparative Example 5-1), (Comparative Example 5-2), and (Comparative Example 5-3).

(Design Tolerance)

FIG. 20 shows measurement results of a relationship between the inroad amount and the abutment pressure with a gap between the center line “m” and the normal line “v” of the flexible sheet member 4-a used in (Installation Example 5) being changed. In this case, it is understood that, when the center line “m” is positioned downstream of the normal line “v”, an amount of change in abutment pressure is small and the design tolerance is large.

(Abutment Pressure Increase)

In Comparative Example 5-1, similarly to Comparative Example 1-1, the maximum abutment pressure was increased to about 150% of the initial abutment pressure. On the other hand, however, in the case of Installation Example 5, the maximum abutment pressure was remained 110% or lower of the initial abutment pressure.

(Posture Pressure Change of Flexible Sheet Member)

In Comparative Example 5-1, along with the change of the posture of the flexible sheet member 4-a, the change in abutment pressure is large, but in Installation Example 5, the change in abutment pressure is small.

Further, in Comparative Example 5-2, compared to the other installation examples, there is no wall for suppressing the deformation of the flexible sheet member 4-a, so the deformation of the flexible sheet member 4 tends to be larger, and the abutment pressure tends to decrease along therewith.

On the other hand, when there was an attempt that the inroad amount was made larger and the abutment pressure was increased in an amount corresponding to a decreased amount, the posture deformation of the flexible sheet member 4-a became larger, and accordingly, a sufficient abutment pressure could not be obtained. Therefore, it is difficult to stabilize the abutment state with the structure of Comparative Example 5-2.

(Downstream Surface Sheet Stability)

As illustrated in FIG. 12, in Comparative Example 5-3, a shape of the recess portion of the holding member 4-b is different from those of (Installation Example 1) to (Installation Example 5). An angle of circumference of an arc portion of the flexible sheet member 4-a exceeds 180 degrees.

That is, the opposite wall surfaces forming the recess portion of the holding member 4-b are opened in the direction of the developer carrying member, so the flexible sheet member 4-a is pressed by the holding member 4-b so it is difficult to allow the posture to be held.

Accordingly, when the developer carrying member rotates, the downstream wall surface of the recess portion of the holding member 4-b tends to lean in a direction indicated by the arrow “n” of FIG. 12, and the holding state of the flexible sheet member 4-a becomes unstable. Accordingly, with the structure of Comparative Example 5-3, it is difficult to stabilize the abutment state.

That is, in this embodiment, even without the flexible sheet member 4-a being firmly bonded to the holding member 4-b, in the use state of the apparatus main body, there is a low risk of the flexible sheet member 4-a being removed from the holding member 4-b. Further, the abutment pressure with respect to the developer carrying member can be stabilized.

According to this embodiment, with the above-mentioned structure, the developer regulating apparatus can be provided, in which downsizing of the apparatus main body can be achieved. The developer regulating apparatus has a simple structure enabling the coat regulation while stabilizing the abutment state of the flexible sheet member.

### Embodiment 2

A description is made of a structure of a developer regulating apparatus according to Embodiment 2 of the present invention.

(Overall Structure of Image Forming Apparatus)

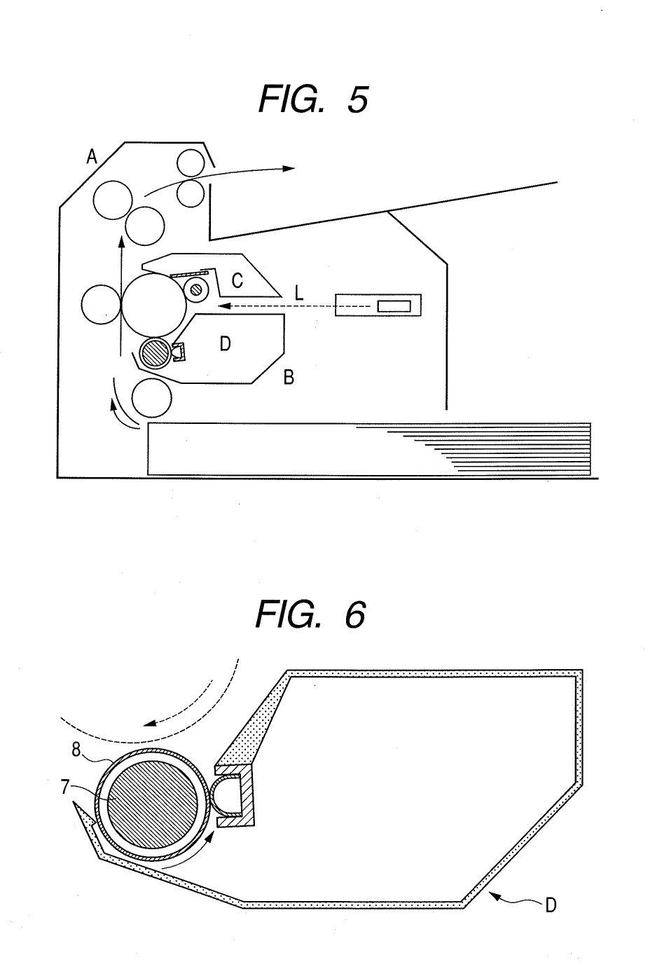

With reference to FIG. 5, an overall structure of an image forming apparatus according to this embodiment is described. FIG. 5 illustrates the overall structure of the image forming apparatus according to this embodiment. In this case, as the image forming apparatus, a monochrome laser printer employing an electrophotographic process is used.

The image forming apparatus according to this embodiment includes the image forming apparatus main body A and the process cartridges B detachable from the apparatus main body A. Each of the process cartridges B includes the electrostatic charging device, the developing apparatus, the cleaning device, the photosensitive drum, and the like which are integrated into one. A structure of the process cartridge B is described later. Further, in this embodiment, a magnetic mono-component toner having an average particle diameter of 6.0 μm is used.

The image forming apparatus according to this embodiment is different from that of Embodiment 1 described above in a point that the developer is supplied to the photosensitive drum by a non-contact developing system. Hereinafter, a description is made only of a development process by the non-contact developing system.

FIG. 6 illustrates a schematic structure of the developing apparatus D according to this embodiment. To the surface of the photosensitive drum on which an electrostatic latent image is formed, the developer is supplied from the developing sleeve 8 serving as the developer carrying member provided to the developing apparatus D.

As illustrated in FIG. 6, between the developing sleeve 8 and the photosensitive drum, in a nearest-neighbor portion, a gap of 280 μm is retained. The developing sleeve 8 rotates in a forward direction with respect to the rotation direction of the photosensitive drum. To the developing sleeve 8, in an image forming process, a rectangular wave of a DC bias=−350 V and an AC bias=1400 Vpp of a frequency f=2200 Hz is applied.

A magnetic toner negatively charged by frictional charging on the developing sleeve 8 is allowed to reciprocate between the photosensitive drum and the developing sleeve by the AC bias in a development portion where the photosensitive drum and the developing sleeve are adjacent to each other. Owing to the relationship between a potential of the electrostatic latent image and a potential based on the bias applied to the developing sleeve 8, flying is performed only on a bright part potential portion, thereby developing the electrostatic latent image.

Note that, the stationary magnet roller 7 contained in the developing sleeve 8, in a developing container and in the vicinity of the development portion, a magnetic pole is provided. In this embodiment, a magnetic force of the magnetic pole in the vicinity of the development portion is set to 800 G on the surface of the developing sleeve, thereby preventing the toner having an inappropriate electric charge which cannot be controlled by potential setting from erroneously flying onto a Vd portion.

The transferring roller brought into contact with the photosensitive drum is applied with a DC voltage. Between the transferring roller and the photosensitive drum, a magnetic field is formed. As a result, the toner image realized on the photosensitive drum receives a force of the magnetic field to be transferred from the surface of the photosensitive drum onto the sheet material.

On the other hand, the untransferred toner which is not transferred onto the recording sheet and remains on the photosensitive drum 1 is scraped from the drum surface by a cleaning blade made of urethane rubber provided to the cleaning device C and is accommodated in the cleaning container.

As the developing sleeve 8, a metal sleeve which is coated with a conductive resin and has a diameter of 12 mm is used. In the developing sleeve 8, the stationary magnet roller 7 having a predetermined magnetic pole arrangement is provided.

The magnetic toner in the developing container is pulled by a magnetic force with respect to the magnet roller 7 to the surface of the developing sleeve 8. The magnetic toner adhered onto the surface of the developing sleeve 8 is conveyed by the rotation of the developing sleeve 8, and is charged by the frictional charging and is regulated for the coat layer thickness thereof when passing an abutment surface between the developing sleeve 8 and the U-shaped developer regulating apparatus 4.

(Installation of Developer Regulating Apparatus)

Hereinafter, arrangement examples of the developer regulating apparatus 4 according to this embodiment are described in (Installation Example 6), (Installation Example 7), and (Installation Example 8), and in comparison with (Comparative Example) described later, characteristics and effects of this embodiment are described.

Further, for illustration of an installation state of the developer regulating apparatus, similarly to Embodiment 1 described above, the center line “m”, the normal line “v”, and the supporting line “u” are defined.

### Installation Example 6

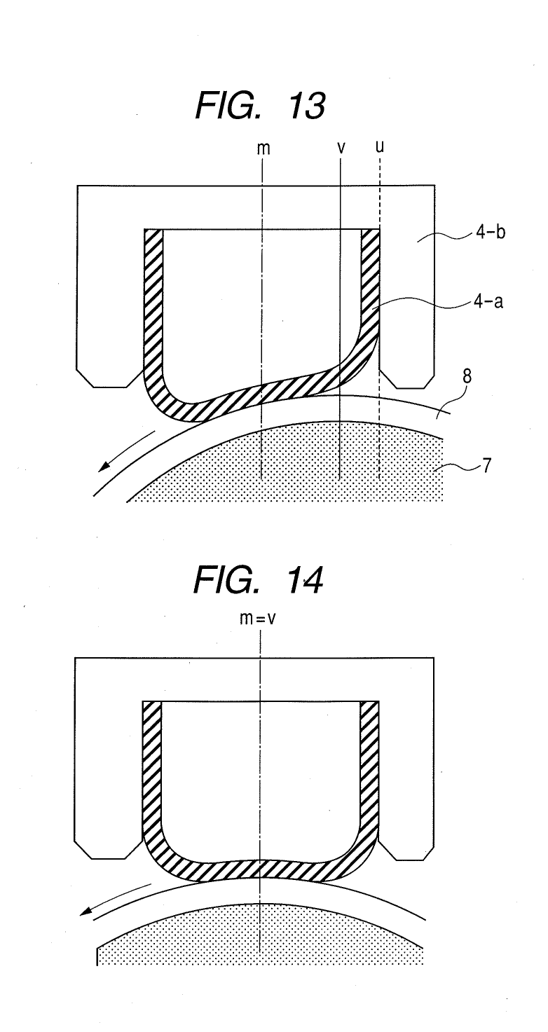

In Installation Example 6 illustrated in FIG. 13, as the flexible sheet member 4-a, sheet-shaped urethane rubber having a JIS-A hardness of 65 degrees and a thickness of 0.5 mm is used. The urethane rubber is curved in a U shape, and is fitted in the recess portion of the holding member 4-b of a square U shape having an inner diameter of 6 mm, and an outer side of the U-shaped arc is allowed to abut on the developing sleeve 8.

Further, in Installation Example 6, the inroad amount of the flexible sheet member 4-a with respect to the developing roller 3 is set such that the abutment pressure of the flexible sheet member 4-a with respect to the developing sleeve 8 is a line pressure of 0.25 N/cm.

Note that, in this embodiment, the abutment pressure of the flexible sheet member 4-a with respect to the developing sleeve 8 was measured by using a sheet-type pressure sensor system I-SCAN (manufactured by NITTA CORPORATION).

Further, in Installation Example 6, the opposite wall surfaces forming the recess portion of the holding member 4-b for holding the opposite ends of the flexible sheet member 4-a are in parallel to each other.

Further, the flexible sheet member 4-a is held in a non-bonding manner with respect to the holding member 4-b. In this embodiment, the center line “m” is downstream of the normal line “v” of the surface of the developing sleeve 8. A distance between the center line “m” and the normal line “v” is set to 2.0 mm. In this case, the supporting line “u” is positioned upstream of the normal line “v” in the rotation direction of the developing sleeve 8.

In this case, in order to verify the effects of (Installation Example 6) described above, as a comparative example for (Installation Example 6), (Comparative Example 6-1) is provided as follows. Note that, the results of the comparison therebetween are described later.

### Comparative Example 6-1

FIG. 14 illustrates a schematic structure of Comparative Example 6. Compared to (Installation Example 6) described above, Comparative Example 6 is different therefrom in installation state of the U-shaped flexible sheet member 4-a. Note that, the abutment pressure of the flexible sheet member 4-a with respect to the developing sleeve 8 is set to the same value as that of (Installation Example 6), and physical property or the like of the rubber sheet used is the same as that of (Installation Example 6).

As illustrated in FIG. 14, in Comparative Example 6, the center line “m” is positioned on the same line as the normal line “v” on the surface of the developing sleeve 8, that is, the vertex of the arc portion of the U-shaped flexible sheet member 4-a abuts on the center line “m”.

### Installation Example 7

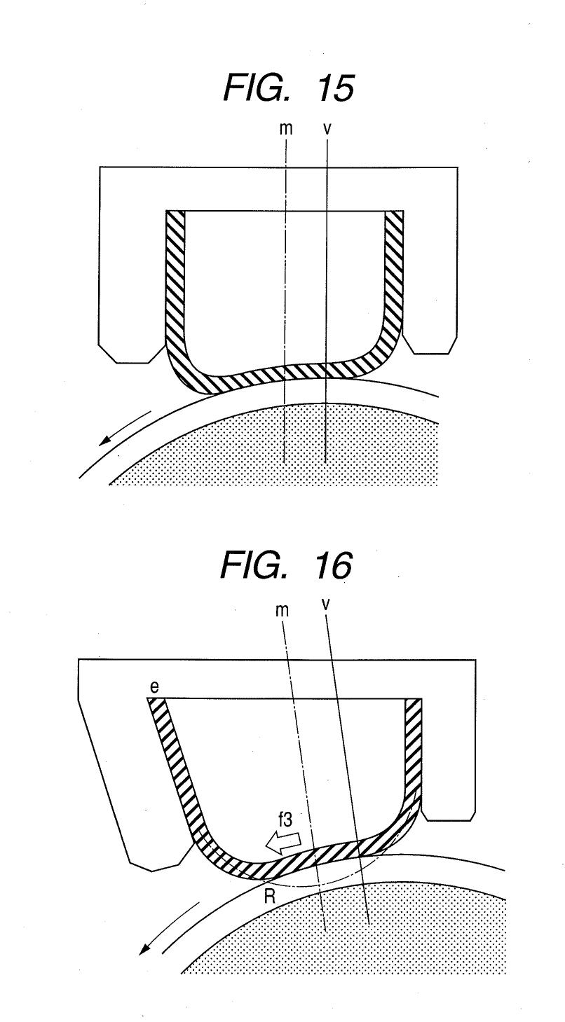

FIG. 15 illustrates a schematic structure of Installation Example 7. Installation Example 7 is different from (Installation Example 6) described above in installation state of the U-shaped flexible sheet member 4-a. Note that, the abutment pressure of the flexible sheet member 4-a with respect to the developing sleeve 8 is set to the same value as that of (Installation Example 6), and physical property or the like of the rubber sheet used is also the same as that of (Installation Example 6).

As illustrated in FIG. 15, in Installation Example 7, the center line “m” is positioned downstream of the normal line “v” on the surface of the developing sleeve 8 in the rotation direction of the developing sleeve 8, and a distance from the center line “m” to the normal line “v” is set to 1.0 mm.

### Installation Example 8

Next, a description is made of (Installation Example 8) which is different from (Installation Example 6) and which illustrates an installation state of the developer regulating apparatus 4 according to this embodiment.

FIG. 16 illustrates a schematic structure of Installation Example 8. Installation Example 8 includes a structure in which the opposite wall surfaces forming the recess portion of the holding member 4-b for holding the U-shaped flexible sheet member 4-a are not parallel to each other and are narrowed toward the developing sleeve 8.

In Installation Example 8, the downstream wall surface of the recess portion of the holding member 4-b has an inclination of 18 degrees with respect to the upstream wall surface. Further, the setting is performed such that, a distance between opposite end portions of the arc of the flexible sheet member 4-a, that is, opposite contact points between the flexible sheet member 4-a and the holding member 4-b in a state prior to allowing the flexible sheet member 4-a to abut on the developing sleeve 8 is about 6 mm. The arc R of FIG. 16 indicates the position of the flexible sheet member 4-a in a state where the flexible sheet member 4-a is not allowed to abut on the developing sleeve 8.

Also in Installation Example 8, the inroad amount is set to a predetermined amount such that the abutment pressure with respect to the developing sleeve 8 is a line pressure of 0.25 N/cm. Further, like in Installation Example 7, the center line “m” is set downstream of the normal line “v” on the surface of the developing sleeve 8 at a distance of 1.0 mm therefrom in the rotation direction of the developing sleeve 8.

(Consideration Based on Results of Comparison between Installation Examples 6, 7, and 8 and Comparative Example 6-1)

Table 1 shows results of comparison between (Installation Example 6), (Installation Example 7), and (Installation Example 8) of the developer regulating apparatus 4 according to this embodiment and Comparative Example 6-1. Hereinafter, based on the results of the comparison shown in Table 1, characteristics and effects of the developer regulating apparatus 4 according to this embodiment are described.

Note that, the items shown in Table 1 are the same as the items described in Embodiment 1 described above, so the descriptions of the items are omitted here.

(Abutment Pressure Increase)

A structure of the U-shaped flexible sheet member 4-a of (Installation Example 6), (Installation Example 7), and (Installation Example 8) is the same as that described in (Installation Example 1). However, in this embodiment, a magnetic toner is used. Accordingly, compared to Embodiment 1, deformation of the flexible sheet member 4-a tends to occur.

This is because a developer “t” which tends to enter the flexible sheet member 4-a forms a magnetic brush, so a toner conveying force is large, and a pressing function “g” of the developer with respect to the flexible sheet member 4-a is additionally exerted.

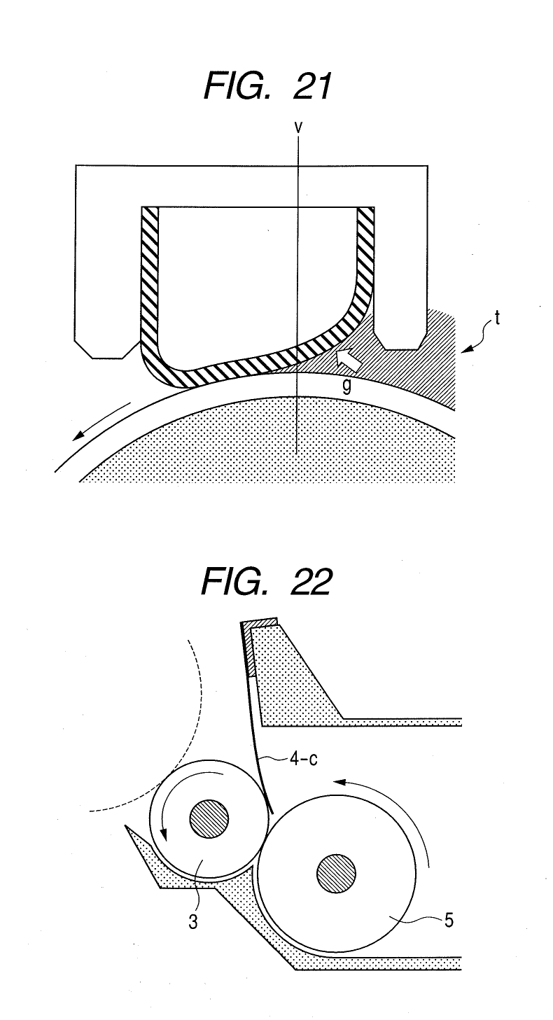

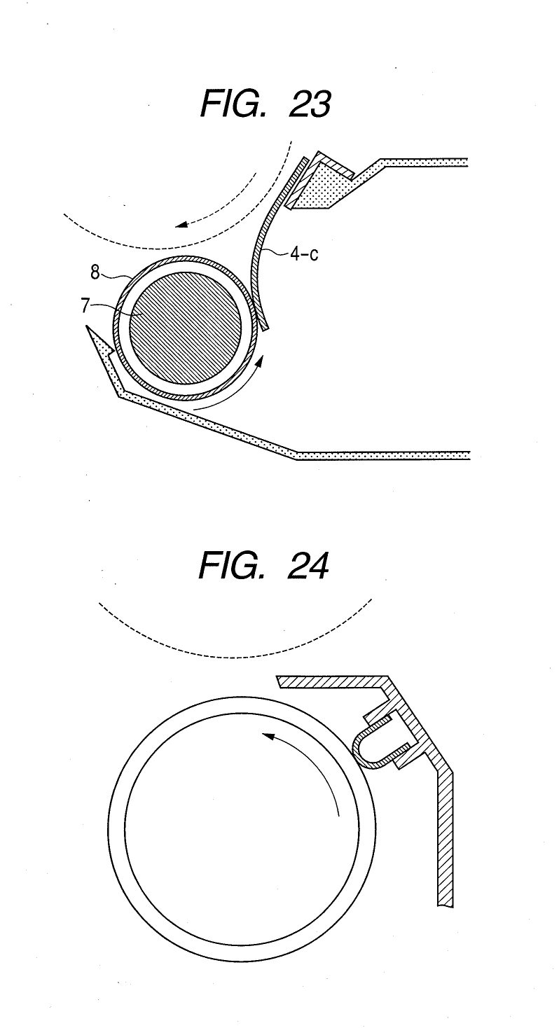

The flexible sheet member 4-a pressed by the magnetic brush of the developer is deformed as illustrated in FIG. 21. As a result, the abutment pressure tends to change.

Regarding the abutment pressure in a state where a conveyed toner is interposed, in the case of (Installation Example 6), the maximum abutment pressure was about 110% of the initial abutment pressure. On the other hand, in Comparative Example 6, the maximum abutment pressure was increased to about 150%. Further, in (Installation Example 7), the maximum abutment pressure increased about 125% was observed, which is close to an allowable limit value.

In a structure of (Installation Example 8), against a force f3 attempting to deform the flexible sheet member 4-a, the downstream edge surface “e” of the flexible sheet member 4-a tends to receive the force, so the deformation of the posture in the downstream of the flexible sheet member 4-a is suppressed. Accordingly, increase in the abutment pressure can be suppressed.

(Posture Pressure Change of Flexible Sheet Member)

As described above, compared to Embodiment 1, the force attempting deformation in the downstream is additionally applied to the flexible sheet member 4-a. Along with this application, while in the structure of (Comparative Example 6-1) a larger change was caused in the abutment pressure, in (Installation Example 6), increase in the abutment pressure could be suppressed to minimum. Further, in (Installation Example 8), the posture of the flexible sheet member could be stabilized. Accordingly, a more stable abutment state than that in (Installation Example 7) was obtained. Further, increase in the abutment pressure could also be suppressed to the maximum abutment pressure of about 110%.

That is, in this embodiment, without firmly bonding the flexible sheet member 4-a to the holding member 4-b, there is a low risk of the flexible sheet member 4-a being removed from the holding member 4-b in the use state of the apparatus main body. Further, the abutment pressure with respect to the developer carrying member can be stabilized.

As described above, according to this embodiment, there may be provided the developer regulating apparatus capable of downsizing the apparatus main body, and performing coat regulation while stabilizing the abutment state of the flexible sheet member by the simple structure.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-157559, filed Jun. 14, 2007, which is hereby incorporated by reference herein in its entirety.

What is claimed is:

1. A developer regulating apparatus for regulating a thickness of a layer of a developer carried by a rotatable developer carrying member, the developer regulating apparatus comprising:
a flexible sheet member, which regulates the thickness of the layer of the developer carried by the developer carrying member, an outer side of an arc of the flexible sheet member being pressed by the developer carrying member; and
a holding member having wall surfaces interposing the flexible sheet member therebetween, for holding the flexible sheet member in a curved state,
wherein in a state where the flexible sheet member is free from being pressed by the developer carrying member, the holding member holds the flexible sheet member so that an angle of circumference of the arc of the flexible sheet member is equal to or smaller than 180 degrees,
a perpendicular bisector of a chord corresponding to the arc in a state where the flexible sheet member is free from being pressed by the developer carrying member is provided downstream in a rotation direction of the developer carrying member with respect to a normal line of a surface of the developer carrying member which is parallel to the perpendicular bisector in a state where the flexible sheet member is pressed by the developer carrying member, and
of the wall surfaces of the holding member interposing the flexible sheet member therebetween, a sheet member holding line of the wall surface upstream in the rotation direction of the developer carrying member is provided coplanar with the normal line or upstream in the rotation direction of the developer carrying member with respect to the normal line.

2. A developer regulating apparatus according to claim 1, wherein the flexible sheet member is fixed to the wall surface upstream in the rotation direction of the developer carrying member.

3. A developer regulating apparatus according to claim 2, wherein the flexible sheet member is bonded to the wall surface upstream in the rotation direction of the developer carrying member.

4. A developer regulating apparatus according to claim 1, wherein the flexible sheet member is held by the holding member without being bonded to the wall surface of the holding member.

5. A developer regulating apparatus according to claim 1, wherein the holding member has a recess portion and the wall surfaces provided inside the recess portion, for interposing the flexible sheet member therebetween.

6. A developer regulating apparatus according to claim 5, wherein the flexible sheet member has opposite end portions positioned inside the recess portion.

7. A developing apparatus comprising:
a rotatable developer carrying member, which carries a developer; and
a developer regulating apparatus, which regulates a thickness of a layer of the developer carried by the developer carrying member, the developer regulating apparatus comprising:
a flexible sheet member, which regulates the thickness of the layer of the developer carried by the developer carrying member, an outer side of an arc of the flexible sheet member being pressed by the developer carrying member; and
a holding member having wall surfaces interposing the flexible sheet member therebetween, for holding the flexible sheet member in a curved state,
wherein in a state where the flexible sheet member is free from being pressed by the developer carrying member, the holding member holds the flexible sheet member so that an angle of circumference of the arc of the flexible sheet member is equal to or smaller than 180 degrees,
a perpendicular bisector of a chord corresponding to the arc in a state where the flexible sheet member is free from being pressed by the developer carrying member is provided downstream in a rotation direction of the developer carrying member with respect to a normal line of a surface of the developer carrying member which is parallel to the perpendicular bisector in a state where the flexible sheet member is pressed by the developer carrying member, and
of the wall surfaces of the holding member interposing the flexible sheet member therebetween, a sheet member holding line of the wall surface upstream in the rotation direction of the developer carrying member is provided coplanar with the normal line or upstream in the rotation direction of the developer carrying member with respect to the normal line.

8. A developing apparatus according to claim 7, wherein the flexible sheet member is fixed to the wall surface upstream in the rotation direction of the developer carrying member.

9. A developing apparatus according to claim 8, wherein the flexible sheet member is bonded to the wall surface upstream in the rotation direction of the developer carrying member.

10. A developing apparatus according to claim 7, wherein the flexible sheet member is held by the holding member without being bonded to the wall surface of the holding member.

11. A developing apparatus according to claim 7, wherein the holding member has a recess portion and the wall surfaces provided inside the recess portion, for interposing the flexible sheet member therebetween.

12. A developing apparatus according to claim 11, wherein the flexible sheet member has opposite end portions positioned inside the recess portion.
